(19) United States
(12) Patent Application Publication
(10) Pub. No.: US 2024/0017674 A1
(43) Pub. Date: Jan. 18, 2024

(54) CONSOLE ASSEMBLY FOR VEHICLE INTERIOR AND A SAFETY SYSTEM THEREOF

(71) Applicant: FAURECIA JAPAN K.K, Hodogaya-ku (JP)

(72) Inventors: Guillaume DEVAUX, Atsugi (JP); Rushikesh Suryawanshi, Maharashtra (IN); Kazushi MOKUDAI, Kanagawa (JP)

(21) Appl. No.: 18/352,184

(22) Filed: Jul. 13, 2023

(30) Foreign Application Priority Data
Jul. 13, 2022 (IN) 202211040233

(51) Int. Cl. B60R 7/04; B62D 65/14

(52) U.S. Cl. CPC B60R 7/04; B62D 65/14

(57) ABSTRACT

A console assembly for a vehicle interior. The console assembly includes a first box arranged on/in a carrier of the vehicle interior and a second box arranged on/in the first box. The console assembly further includes a first bracket arranged on/in the carrier and/or the first box, and a second bracket adapted to attach the second box and the first box. Further included is a strap adapted to engage with the first bracket and the second bracket. The engaged strap is configured to secure and/or restrict the separation of the second box from the first box, and/or the first box from the carrier.

### TECHNICAL FIELD

The present disclosure relates to the field of console assemblies of vehicles. More particularly the present disclosure relates to an efficient console assembly for vehicle interior, which restricts flying off or separation of the components of the console assembly in an event of a crash. Further, the present disclosure also relates to an efficient safety system or mechanism that may be easily configured with existing console assemblies to restrict flying off or separation of the components of the console assembly in an event of a crash.

### BACKGROUND

Background description includes information that may be useful in understanding the present invention. It is not an admission that any of the information provided herein is prior art or relevant to the presently claimed invention, or that any publication specifically or implicitly referenced is prior art.

Console assembly is generally arranged on a carrier such as a floor or roof in the interior of vehicles for aesthetic or article storage purposes. Existing console assembly generally includes a bottom part that may be in form of a box (first box) being arranged centrally over a floor between front seats in the vehicle interior. The bottom box allows positioning of another part of the console assembly, which may be in form of another box (second box) or storage unit with a lid or an armrest thereon. The lower and upper boxes are generally connected and allow users to access and use these boxes for storing articles therewithin. Further, in some vehicles, one of the boxes (first box) of the console assembly may be arranged on the roof of the vehicle and the other (second) box may be arranged at bottom of the first box.

Existing console assemblies are generally made from brittle material by injection molding, which is why during a crash, the upper box and lower box of the console assembly may get cracks and break easily. This may result in separation or breakage of the first box from the floor or roof of the vehicle interior or the second box from the first box, or both, thereby causing flying of the console assembly or boxes, which may seriously damage the vehicle and may also put the passengers or driver of the vehicle in danger.

Some of the existing console assemblies include a bracket as a safety mechanism to couple the lower box with the upper box, still, the upper box, lower box, and the bracket of these console assemblies may get cracks near the coupling area and break easily during a crash, resulting in breakage or flying off of the lower box from the floor or roof of the vehicle interior or the upper box from the lower box, or both.

There is, therefore, a need to overcome the above drawback, limitations, and shortcomings associated with existing console assembly, and provide a simple, light-weight, cost-effective, and efficient console assembly that restricts flying off or separation of the lower box of the console assembly from the carrier and/or the upper box from the lower box in an event of a crash. Further, there is a need to provide a simple, cost-effective, and efficient safety system or mechanism that may be easily configured with existing console assemblies to keep the console assembly intact and restrict flying off or separation of the components of the console assembly in an event of a crash/impact.

### OBJECTS OF THE PRESENT DISCLOSURE

Some of the objects of the present disclosure, which at least one embodiment herein satisfies are as listed herein below.

It is an object of the present disclosure to overcome the above-mentioned drawbacks, limitations, and shortcomings associated with existing console assemblies.

It is an object of the present disclosure to prevent damage to the vehicle interior and prevent passengers or drivers of the vehicle from any harm due to flying off of the components of console assembly in an event of a vehicular crash.

It is an object of the present disclosure to restrict separation or flying off of the components of console assembly in an event of a vehicular crash.

It is an object of the present disclosure to provide an efficient console assembly that restricts flying off or separation of a lower box of the console assembly from the carrier of the vehicle interior and/or an upper box of the console assembly from the lower box in an event of a crash.

It is an object of the present disclosure to provide an efficient safety system or mechanism that may be easily configured with existing console assemblies to keep the console assembly intact and restrict flying off or separation of the components of the console assembly in an event of a crash/impact.

It is an object of the present disclosure to provide a strap structure that can keep the components of the console assembly intact together and with the carrier of the vehicle, and which can restrict flying off or separation of the components of the console assembly in an event of a crash/impact.

### SUMMARY

The present disclosure relates to a simple, lightweight cost-effective, and efficient console assembly that restricts flying off or separation of the components of the console assembly in an event of a crash. Further, the present disclosure also relates to a simple, lightweight, cost-effective, and efficient safety system or mechanism that may be easily configured with existing console assemblies to restrict flying off or separation of the components of the console assembly in an event of a crash.

An aspect of the present disclosure pertains to a console assembly for a vehicle interior. The console assembly may comprise a first box arranged on/in a carrier such as roof or floor of the vehicle interior, and a second box is arranged on/in the first box. When the first box is arranged on the floor of the vehicle interior, the second box may be arranged on top of the first box. Similarly, when the first box is arranged on the roof of the vehicle interior, the second box may be arranged under the first box. The first box and the second box may be adapted to store one or more articles therein, and/or accommodate the one or more articles thereon.

In an alternate aspect, the first box may be a housing adapted to store one or more articles therein, and the second box may be an armrest with or without storage capacity.

Another aspect of the present disclosure pertains to a safety system for the console assembly. The safety system and the console assembly may further involve a first bracket configured with the carrier and/or the first box. The second box and the first box may be attached through a second bracket. Further, the safety system and console assembly may involve a strap adapted to engage with the carrier and/or first box and the second box. More particularly, the strap is adapted to engage with the first bracket and the second box to secure and/or restrict separation of the second box from the first box, and/or the first box from the carrier in an event of a crash/impact. The engaged strap may be configured to secure and/or restrict separation of the second box from the first box, and/or the first box from the carrier in an event of a (vehicular) crash/impact and may also keep the console assembly intact during normal operation as well.

In an aspect, the first box may be slidably or fixedly coupled to the carrier. The first box may be coupled to the carrier using a third bracket and/or the first bracket. Further, the second box may also be slidably or fixedly arranged on/in the first box using the second bracket.

In an aspect, the second bracket may have a U-shaped profile comprising two legs extending at an oblique angle or perpendicularly from two extremer ends of a flat longitudinal member. The second bracket may be configured with the first box and the second box, such that the flat longitudinal member is placed over/on the first box, and the two legs are projecting in a direction towards the second box, enabling fastening of a first surface of the two legs to the first box and a second free surface of the two legs to the second box using fasteners. In an aspect, the second free surface of the two legs may also comprise a rail assembly to slidably configure the second box on/in the first box.

In an aspect, the strap may be made of a material selected from flexible plastic, and/or textile fabric. The strap may be fabricated for example by stitching such that loops are formed at two extreme ends of the strap being adapted to lace the strap around the second bracket. More particularly, the strap may be fabricated such that a single loop is formed at a first end of the strap, and a double loop is formed at a second end of the strap. The single loop may be adapted to be engaged to the first bracket and the double loop may be adapted to be engaged to the second bracket by lacing the single loop into the double loop.

In an alternate aspect, one end of the strap may be directly fixed to the carrier or the first box using any known fastening means like by a bolts and nuts. Similarly, other end of the strap may be directly fixed to the second box using any known fastening means like by a bolts and nuts.

In an aspect, a first end of the first bracket may comprise a first portion adapted to be attached to the first box, and a second end of the first bracket comprises a hook-shaped portion adapted to engage the single loop end of the strap.

Accordingly, the strap with improved design and structure may keep the components of the console assembly intact together and with the carrier of the vehicle. The strap may further restrict flying off or separation of the components of the console assembly in an event of a crash. Specifically, the strap restricts flying off or separation of the first box of the console assembly from the carrier of the vehicle interior and/or the second box from the first box in the event of a crash/impact.

Besides, the use of only three components i.e. the first bracket, the second bracket, and the strap in the proposed safety system makes the safety system as well as the overall console assembly simple, lightweight, cost-effective, and efficient, and also allows the safety system to be easily configured with any existing console assembly.

According to another aspect, a method for securing a console assembly for a vehicle interior comprising the steps of a) engaging/hooking one or more strap around a second bracket wherein the second bracket is adapted to arrange a second box on/in a first box of the console assembly, b) engaging/hooking the one or more strap to a first bracket wherein the first bracket is being arranged on a carrier and/or the first box. The engaged strap may be configured to secure and/or restrict separation of the second box from the first box, and/or the first box from the carrier in case of an impact/crash.

In an aspect, the strap may be fabricated such that loops are formed at extreme ends of the strap adapted to lace around the second bracket, wherein the strap may be fabricated such that a single loop is formed at a first end and a double loop is formed at a second end of the strap. Further, the single loop may be adapted to be engaged to the first bracket and the double loop may be adapted to be engaged to the flat longitudinal member or the legs of the second bracket. More particularly, the single loop may be laced into the double loop for engaging/tightening/hooking the one or more strap around a second bracket and then the single loop may be hooked into a hook portion of the first bracket.

In an alternate aspect, the strap may be fabricated such that at least a portion on the surface of the strap has detents and one extreme end of the strap has a locking block with a slot. The strap may be adapted to loop around the second bracket. Further, the strap may be engaged to the first bracket by clipping one free end of the strap into the slot of the locking block where the detent gets locked and thus forming a closed loop that is hooked into the into a hook-portion of the first bracket.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1A to 1D illustrate exemplary views of the proposed console assembly with a safety system comprises a flexible plastic strap, in accordance with an embodiment of the present disclosure.

FIG. 1E illustrates exemplary views of the proposed console assembly with a safety system comprises a textile strap, in accordance with an alternate embodiment of the present disclosure.

FIG. 2A illustrates an exemplary view of the textile (nylon) strap of the proposed console assembly or safety system, in accordance with an embodiment of the present disclosure.

FIG. 2B illustrates an exemplary view of the flexible plastic strap of the proposed console assembly or safety system, in accordance with an embodiment of the present disclosure.

FIG. 3 illustrates an exemplary view of the first bracket of the proposed console assembly or safety system, in accordance with an embodiment of the present disclosure.

FIG. 4 illustrates an exemplary view of the first bracket configured with the flexible plastic strap, in accordance with an embodiment of the present disclosure.

FIG. 5 illustrates exemplary views depicting the configuration of the first bracket with the first box of the console assembly, in accordance with an embodiment of the present disclosure.

FIG. 6 illustrates an exemplary view of the second bracket of the proposed console assembly or safety system, in accordance with an embodiment of the present disclosure.

FIG. 7 illustrates an exemplary view depicting the configuration of the second bracket with a strap, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention.

Embodiments of the present disclosure relate to an efficient console assembly for vehicle interior, which restricts flying off or separation of the components of the console assembly in an event of a crash. Further, the present disclosure also relates to an efficient safety system or mechanism that may be easily configured with existing console assemblies to restrict flying off or separation of the components of the console assembly in an event of a crash.

According to an aspect, the present disclosure elaborates upon a console assembly for a vehicle interior. The console assembly can include a first box being arranged on/in a carrier of the vehicle interior, and a second box being arranged on/in (over or under) the first box. The console assembly can further include a first bracket configured with the carrier and/or the first box, a second bracket adapted to attach the second box and the first box, and a strap adapted to engage with the first bracket and the second bracket. The engaged strap can be configured to secure and/or restrict the separation of the second box from the first box, and/or the first box from the carrier.

In an embodiment, the second bracket can have a U-shaped profile comprising two legs extending at an oblique angle or perpendicularly from two extremer ends of a flat longitudinal member.

In an embodiment, the second bracket can be configured with the first box and the second box, such that the flat longitudinal member is placed on/over the first box, and the two legs are projecting in a direction towards the second box, enabling fastening of a first surface of the two legs to the first box and a second free surface of the two legs to the second box using fasteners. In an embodiment, the second free surface of the two legs can also include a rail assembly to slidably configure the second box on/in the first box.

In an embodiment, the strap can be made of a material selected from flexible plastic, and/or textile fabric, but not limited to the likes.

In an embodiment, the strap can be fabricated such that loops are formed at two extreme ends of the strap being adapted to lace the strap around the second bracket. More particularly the strap can be fabricated such that a single loop is formed at a first end of the strap, and a double loop is formed at a second end of the strap.

In an embodiment, the double loop can be adapted to be engaged to the second bracket by lacing the single loop into the double loop and the single loop can be adapted to be engaged to the first bracket more particularly into a hook-shaped portion of the second bracket.

In an embodiment, a first end of the first bracket can include a first portion adapted to be attached to the first box, and a second end of the first bracket can include the hook-shaped portion adapted to engage the single loop end of the strap.

In an embodiment, the first box, and the second box can be adapted to store one or more articles therein, and/or accommodate the one or more articles thereon. In an alternate embodiment, the first box can be a housing adapted to store one or more articles therein and the second box can be an armrest with or without storage capacity.

In an embodiment, the carrier can be a floor or a roof of the vehicle interior.

In an embodiment, the second box can be slidably arranged on/in the first box. In an embodiment, the first box can be slidably or fixedly arranged on/over the carrier.

In an embodiment, the first box and the second box can be attached through a pair of the second bracket that can be arranged at intervals in a front-rear direction of the vehicle. The strap can be adapted to engage with only one of the second bracket that is arranged at a rear side of the vehicle.

According to another aspect, the present disclosure elaborates upon a safety system for a console assembly of a vehicle interior. The safety system can include a first bracket adapted to be configured to a carrier of the vehicle interior and/or a first box of the console assembly, where the first box can be arranged on/in the carrier. The safety system can further include a second bracket adapted to arrange a second box of the console assembly on/in the first box, and a strap adapted to engage with the first bracket and the second bracket. The engaged strap can be configured to restrict the separation of the second box from the first box, and/or the first box from the carrier.

In an embodiment, the second bracket of the safety system can have a U-shaped profile comprising two legs extending at an oblique angle or perpendicularly from two extremer ends of a flat longitudinal member. The second bracket can be configured with the first box and the second box, such that the flat longitudinal member of the second bracket is placed over the first box, and the two legs are projecting in a direction towards the second box, enabling fastening of a first surface of the two legs to the first box and a second free surface of the two legs to the second box using fasteners. In an embodiment, the second free surface of the two legs can also include a rail assembly to slidably configure the second box on/in the first box.

In an embodiment, the strap can be fabricated using a textile fabric and/or flexible plastic such that a single loop is formed at a first end of the strap, and a double loop is formed at a second end of the strap. The single loop can be adapted to be engaged to the first bracket and the double loop can be adapted to be engaged to the second bracket.

In an embodiment, a first end of the first bracket can include a first portion adapted to be attached to the first box, and a second end of the first bracket can include a hook-shaped portion adapted to engage the single loop end of the strap.

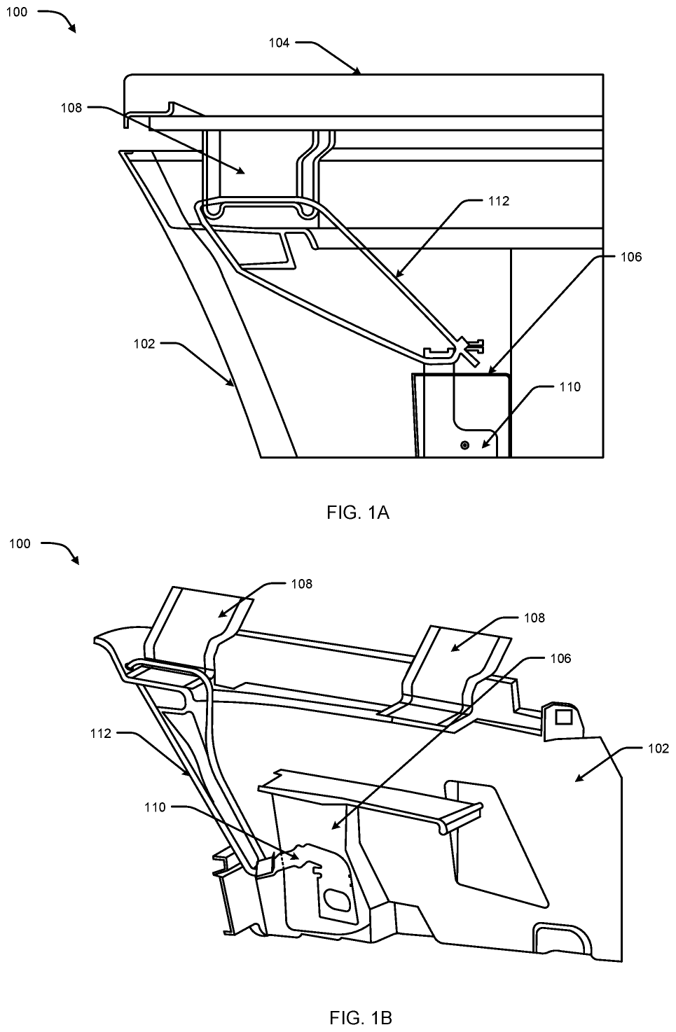

Referring to FIG. 1A to 1D, the proposed console assembly 100 can include a first box 102 being arranged on/in a carrier such as a roof or floor of the vehicle interior, but not limited to the like. Further, a second box 104 can be arranged on/in the first box 102. For instance, when the carrier is selected as the floor of the vehicle, the first box 102 can be arranged on/in the floor, and the second box 104 can be arranged on top of the first box 102. Similarly, (not shown) when the carrier is selected as the roof of the vehicle interior, the first box 102 can be arranged on/in the roof of the vehicle interior, and the second box 104 can be arranged on and under the first box 102. The first box 102 and the second box 104 can be adapted to store one or more articles therewithin, and/or accommodate the one or more articles thereon. The inner area of both boxes 102, 104 can allow users to store the articles therewithin. Further, as shown in FIG. 1D, an armrest or holder (collectively designated as 114, herein) can be fixedly or movably arranged on the second box 104 using a sliding assembly 116, which can allow users to accommodate the articles thereon.

The console assembly 100 and safety system thereof can further include a first bracket 110 arranged on/in the carrier and/or the first box 102. The second box 104 and the first box 102 can be attached through a second bracket 108. Further, the safety system and console assembly 100 can include a strap 112 forming at least one loop and adapted to engage with the first bracket 110 and the second bracket 108. The engaged strap 112 can be configured to keep the console assembly 100 intact during normal operation and can also restrict the separation of the second box 104 from the first box 102, and/or the first box 102 from the carrier in an event of a (vehicular) crash/impact. More particularly as shown in FIG. 1B, the second box 104 and the first box (102, hidden in FIG. 1B) can be attached through a pair of the second bracket 108 arranged at intervals in the front-rear direction of the vehicle. The strap 112 is adapted to engage with only one of the second bracket 108 which is arranged at the rear side of the vehicle.

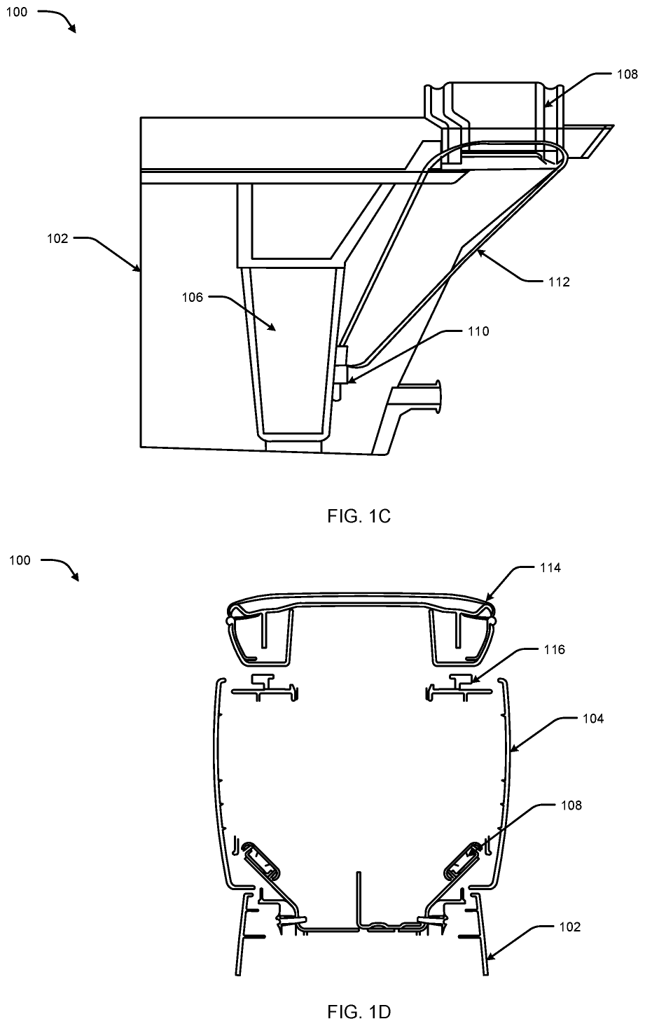

In an embodiment, the strap 112 can be made of a material selected from flexible plastic, and/or textile fabric, but not limited to the likes. Referring to FIGS. 2A and 1E, the strap 112 is made of nylon fabric can be fabricated for example by stitching (hashed area of FIG. 2) such that a single loop 204 is formed at a first end of the strap 112 and a double loop 202 is formed at a second end of the strap 112. The single loop 204 can be adapted to be engaged to the first bracket 110 and the double loop 202 can be adapted to be engaged to a flat longitudinal member or the legs of the second bracket 108. Referring to FIGS. 2B and 1A, the strap 112 can be made of flexible plastic and fabricated such that at least a portion on the surface of the strap 112 has one or more detent(s) (112-3) and one extreme end of the strap has a locking block (112-1) with a slot (112-2). The strap 112 can be adapted to loop around the second bracket 108, and the strap to be engaged to the first bracket 110 by clipping one free end of the strap 112 into the slot 112-2 of the locking block 112-2 in which the detent gets locked and thus the strap 112 is forming a closed loop that is hooked into a hook-shaped portion 304 of the first bracket 110.

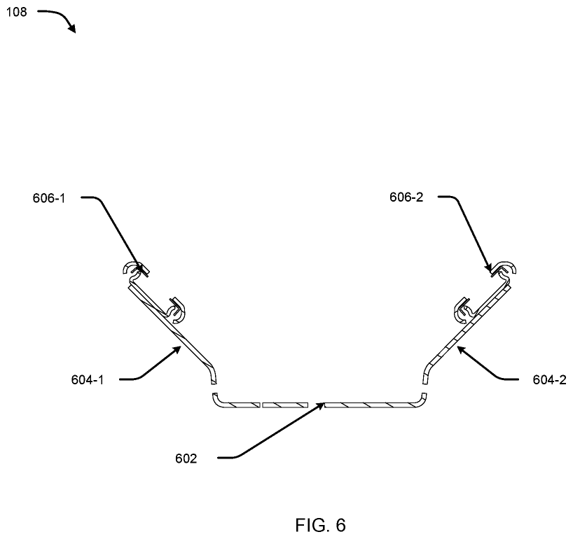

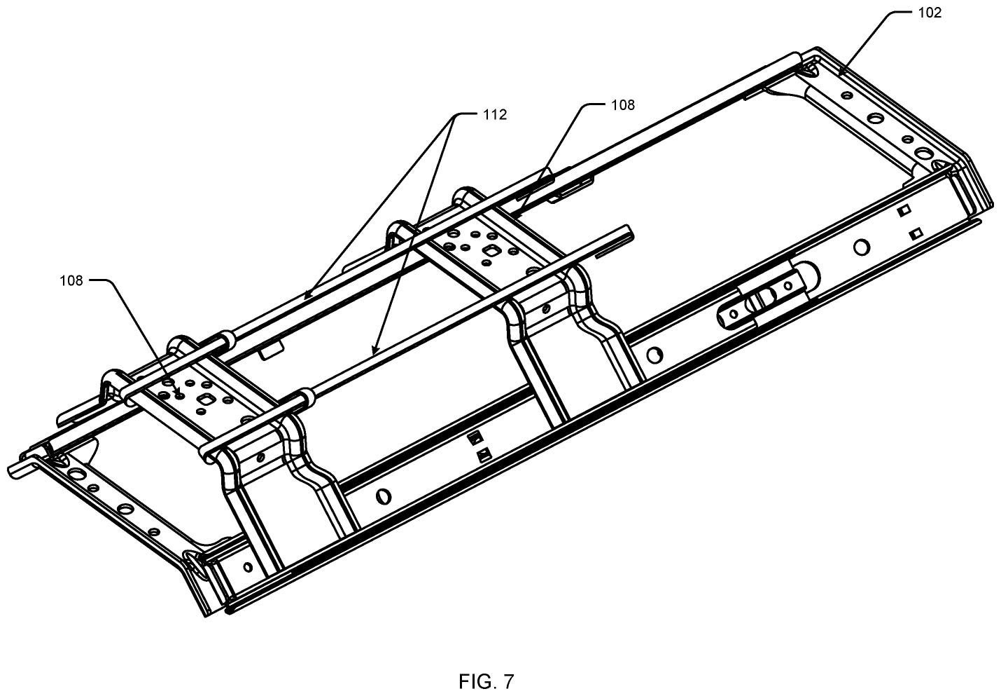

Referring to FIG. 6, in an embodiment, the second bracket 108 can have a U-shaped profile including two legs 604-1, 604-2 extending at an oblique angle or perpendicularly from two extremer ends of a flat longitudinal member 602. The second bracket 108 can be configured with the first box 102 and the second box 104 as shown in FIG. 7, such that the flat longitudinal member 602 is placed on/over the first box 102, and the two legs 604-1, 604-2 are projecting in a direction towards the second box 104, enabling fastening of a first surface of the two legs 604-1, 604-2 to the first box 102 and a second free surface of the two legs to the second box 104 using fasteners. Further, the two legs 604-1, 604-2 can include an engaging portion 606-1, 606-2 to couple the second bracket 108 to the first box 102 and/or the second box 104.

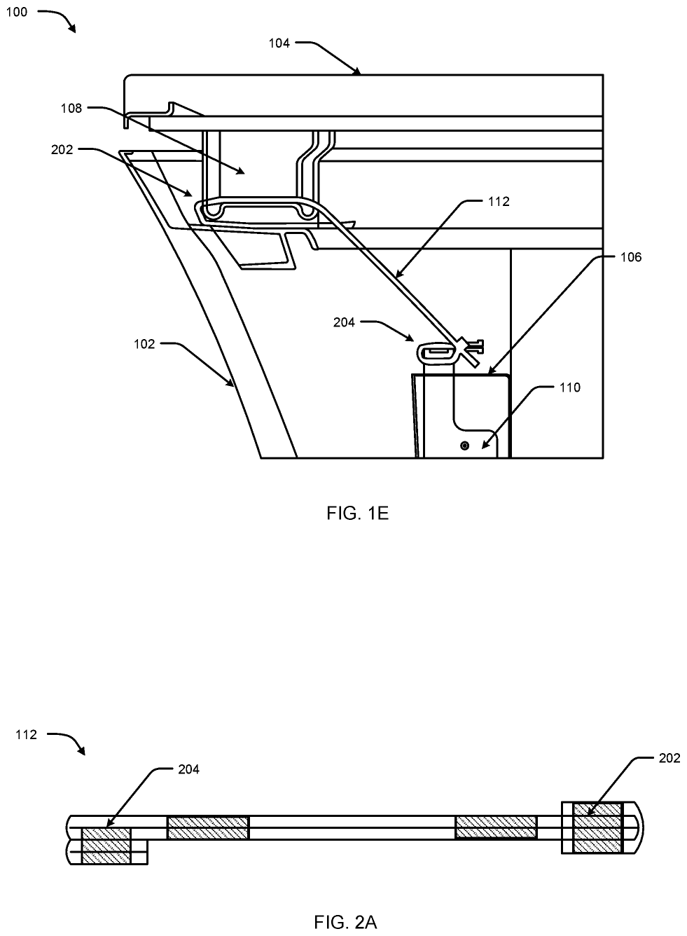

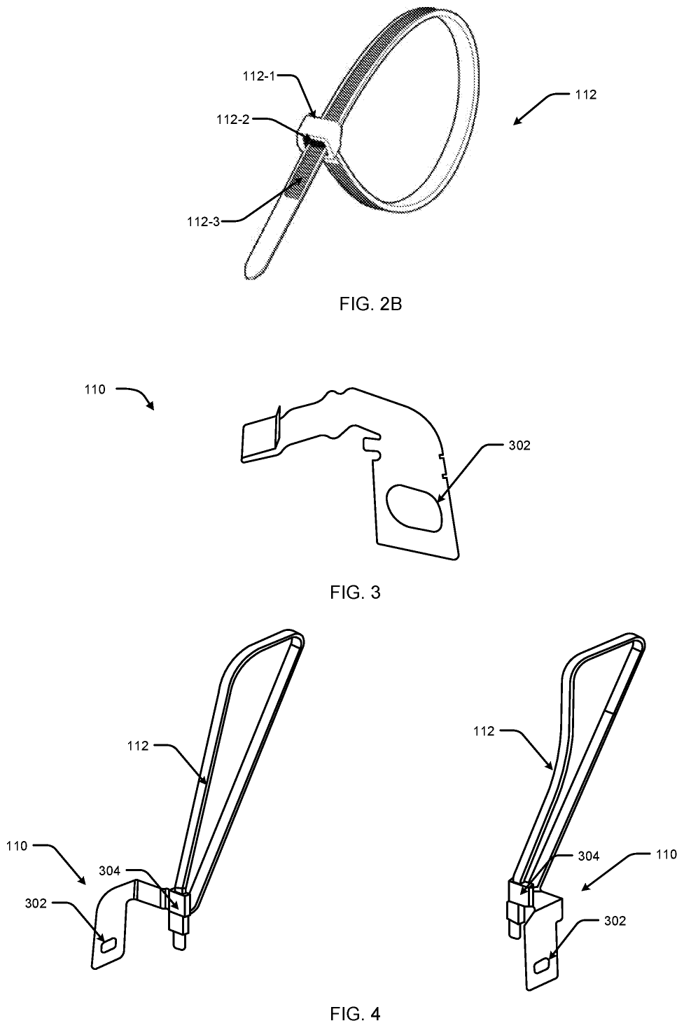

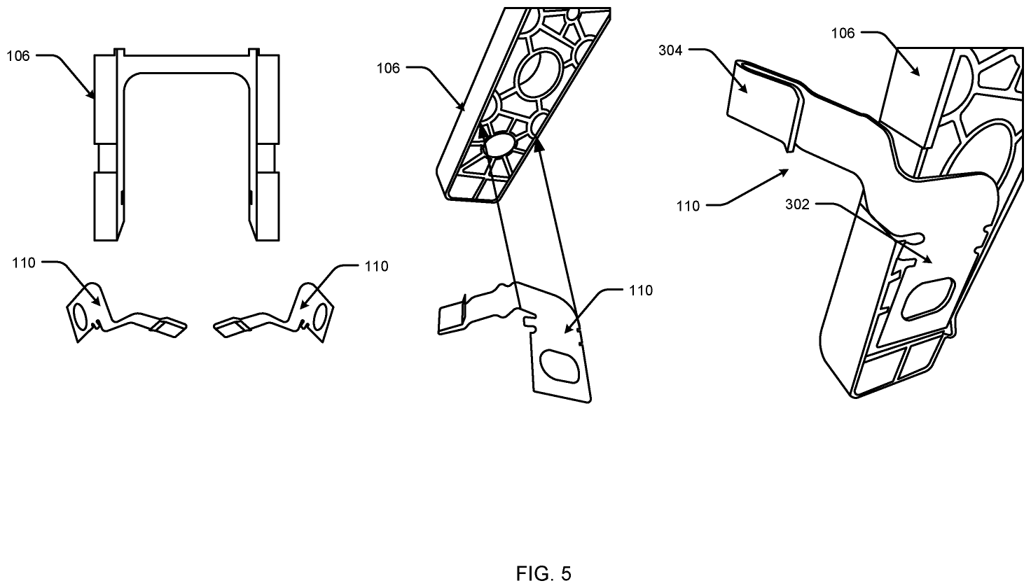

Referring to FIGS. 3 to 4, in an embodiment, a first end of the first bracket 110 can include a first portion 302 adapted to be attached to the first box 102, more particularly at a lower surface of a body 106 of the first box 102 as shown in FIG. 5, and a second end 303 of the first bracket 110 can include a hook-shaped portion 304 adapted to engage the strap 112 by clipping and hooking it into the hook-shaped portion 304 of the second bracket 110 as shown in FIG. 4.

In an embodiment, the first box 102 can be slidably or fixedly coupled to the carrier to allow the user to adjust it as per convenience. Further, the first bracket 110 can be coupled to a body 106 of the first box 102 or directly to the carrier to allow coupling of the single loop of the strap 112 to the first bracket 110. In another embodiment, the second box 104 can also be slidably arranged on/in the first box 102 using a sliding assembly and/or the second bracket 108, which can allow the user to adjust the second box 104 as per convenience and allow the user to open a top of the first box 102 to store the articles therewithin.

In an embodiment, a method for securing a console assembly 100 for a vehicle interior can include the steps of a) engaging/hooking one or more strap 112 around a second bracket 108 wherein the second bracket 108 is adapted to arrange a second box 104 on/in a first box 102 of the console assembly 100, b) engaging/hooking the one or more strap 112 to a first bracket 110 wherein the first bracket 110 is being arranged on a carrier and/or the first box 102. The engaged strap 112 can be configured to secure and/or restrict separation of the second box 104 from the first box 102, and/or the first box 102 from the carrier in case of an impact/crash.

In an embodiment, as shown in FIGS. 2A and 1E, the strap 112 can be fabricated such that loops are formed at extreme ends of the strap 112 adapted to lace around the second bracket 108, wherein the strap 112 is fabricated such that a single loop 204 is formed at a first end and a double loop 202 is formed at a second end of the strap. The single loop 204 can be adapted to be engaged to the first bracket 110 and the double loop 202 is adapted to be engaged to the flat longitudinal member or the legs of the second bracket 108. More particularly, the single loop 204 can be laced into the double loop 202 for engaging/tightening/hooking the one or more strap 112 around a second bracket 108 and then the single loop 204 is hooked into the hook-shaped portion 304 of the first bracket 110.

In another (second) embodiment, as shown in FIGS. 2B and 1A, the strap 112 can be fabricated such that at least a portion on the surface of the strap 112 has detent(s) 112-3 and one extreme end of the strap 112 has a locking block 112-1 with a slot 112-2, wherein the strap can be adapted to loop around the second bracket 108, and the strap 112 can be engaged to the first bracket 110 by clipping one free end of the strap into the slot 112-2 of the locking block 112-1 where the detent(s) 112-3 gets locked and thus forming a closed-loop which is hooked into the hook-shaped portion 304 of the first bracket 110.

Therefore, the strap 112 with improved design and structure of the present invention can keep the components of the console assembly 100 intact together and with the carrier of the vehicle in normal condition, and the strap 112 can further restrict flying off or separation of the components of the console assembly 100 in an event of a vehicular impact/crash. Specifically, the strap 112 can restrict flying off or separation of the first box 102 of the console assembly 100 from the carrier of the vehicle interior and/or the second box 104 from the first box 102 in the event of a crash, thereby preventing any damage to the vehicle interior and keeping passengers or driver of the vehicle out of danger.

More particularly, in implementation upon an impact/collision begin applied on the vehicle, of the two second brackets 108, the engaged second bracket 108 which is at the rear side of the vehicle broke first, then the back part of the second box 104 may be lifted, and in such a case, the strap 112 secures and suppressed the amount of lift of the second box 104 thus the flying off or separation of the first box 102 of the console assembly 100 from the carrier and/or the second box 104 from the first box 102.

Besides, the use of only three components i.e the first bracket 110, the second bracket 108, and the strap 112 in the proposed safety system makes the safety system as well as the overall console assembly 100 simple, lightweight, cost-effective, and efficient, and also allows the safety system to be easily configured with any existing console assembly 100.

It is to be appreciated by a person skilled in the art that while various embodiments and drawings of the present disclosure elaborate upon the use of a single or two textile strap, first bracket and second bracket, however, the number of straps, the first bracket, and the second bracket can be varied based on the shape and size of the console assembly and as per user requirement to satisfy vehicular safety standards, and all such embodiments are well within the scope of the present disclosure. Besides, the structure of the first bracket and second bracket can be slightly modified to allow the user to connect the strap to thereto in a different scheme, still, all such embodiments will also be well within the scope of the present disclosure.

Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

The proposed invention overcomes the above-mentioned drawbacks, limitations, and shortcomings associated with existing console assemblies.

The proposed invention prevents damage to the vehicle interior and prevents passengers or drivers of the vehicle from any harm due to flying off of the components of console assembly in an event of a vehicular crash.

The proposed invention restricts separation or flying off of the components of console assembly in an event of a vehicular crash.

The proposed invention provides a simple, light-weight, cost-effective, and efficient console assembly that restricts flying off or separation of a lower box of the console assembly from the carrier of the vehicle interior and/or an upper box of the console assembly from the lower box in an event of a crash.

The proposed invention provides a console assembly that can be easily arranged on the floor or roof of the vehicle interior, and which restricts flying off or separation of the components of the console assembly in an event of a crash.

The proposed invention provides a simple, cost-effective, and efficient safety system or mechanism that may be easily configured with existing console assemblies to keep the console assembly intact and restrict flying off or separation of the components of the console assembly in an event of a crash.

The proposed invention provides a strap with improved design and structure that can keep the components of the console assembly intact together and with the carrier of the vehicle, and which can restrict flying off or separation of the components of the console assembly in an event of a crash.

1. A console assembly for a vehicle interior, the console assembly comprising:
a first box being arranged on/in a carrier of the vehicle interior, and a second box being arranged on/in the first box; and
a strap adapted to engage with the carrier and/or first box and the second box, wherein the engaged strap is configured to secure and/or restrict separation of the second box from the first box, and/or the first box from the carrier in an event of a crash/impact.

2. The console assembly as claimed in claim 1, wherein a first bracket being arranged on/in the carrier and/or the first box, and a second bracket is adapted to attach the second box and the first box, wherein the strap is adapted to engage with the first bracket and the second box to secure and/or restrict separation of the second box from the first box, and/or the first box from the carrier in an event of a crash/impact.

3. The console assembly as claimed in claim 2, wherein the second bracket has a U-shaped profile comprising two legs extending at an oblique angle or perpendicularly from two extreme ends of a flat longitudinal member.

4. The console assembly as claimed in claim 3, wherein the second bracket is configured with the first box and the second box, such that the flat longitudinal member is placed over the first box, and the two legs are projecting in a direction towards the second box, enabling fastening of a first surface of the two legs to the first box and a second surface of the two legs to the second box using fasteners.

5. The console assembly as claimed in claim 2, wherein the first box and the second box are attached through a pair of the second bracket that are arranged at intervals in a front-rear direction of the vehicle, and wherein the strap is adapted to engage with only one of the second bracket that is arranged at a rear side of the vehicle.

6. The console assembly as claimed in claim 2, wherein the strap is fabricated such that loops are formed at two extreme ends of the strap being adapted to lace the strap around the second bracket.

7. The console assembly as claimed in claim 2, wherein the strap is fabricated such that a single loop is formed at a first end of the strap, and a double loop is formed at a second end of the strap, wherein the single loop is adapted to be engaged to the first bracket and the double loop is adapted to be engaged to the second bracket.

8. The console assembly as claimed in claim 7, wherein a first end of the first bracket comprises a first portion adapted to be attached to the carrier and/or the first box, and a second end of the first bracket comprises a hook-shaped portion adapted to engage the single loop end of the strap.

9. The console assembly as claimed in claim 1, wherein the strap is fabricated such that at least a portion on the surface of the strap has detent(s) and one extreme end of the strap has a locking block with a slot, wherein the strap is adapted to loop around the second bracket, wherein the strap is engaged to the first bracket by clipping other end of the strap into the slot of the locking block in which the detent(s) gets locked and thus forming a closed loop which is hooked into a hook-shaped portion of the first bracket.

10. The console assembly as claimed in claim 1, wherein the strap is made of a material selected from flexible plastic, and/or textile fabric.

11. The console assembly as claimed in claim 1, wherein at least one of the first box and the second box are adapted to store one or more articles therein, and/or accommodate the one or more articles thereon.

12. The console assembly as claimed in claim 1, wherein the carrier is a floor or a roof of the vehicle interior.

13. The console assembly as claimed in claim 1, wherein the second box is slidably arranged on/in the first box.

14. A safety system for a console assembly of a vehicle interior, the safety system comprising:
a first bracket adapted to being arranged on a carrier of the vehicle interior and/or a first box of the console assembly, wherein the first box is adapted to being arranged on the carrier, a second bracket adapted to configure a second box of the console assembly in/on the first box; and
a strap adapted to engage with the first bracket and the second bracket, wherein the engaged strap is configured to secure and/or to restrict separation of the second box from the first box, and/or the first box from the carrier in an event of a crash/impact.

15. The safety system as claimed in claim 14, wherein the second bracket has a U-shaped profile comprising two legs extending at an oblique angle or perpendicularly from two extremer ends of a flat longitudinal member, and wherein the second bracket is configured with the first box and the second box, such that the flat longitudinal member of the second bracket is placed over the first box, and the two legs are projecting in a direction towards the second box, enabling fastening of a first end of the two legs to the first box and a second free end of the two legs to the second box using fasteners.

16. The safety system as claimed in claim 14, wherein the strap is fabricated using a textile fabric such that a single loop is formed at a first end of the strap, and a double loop is formed at a second end of the strap, wherein the single loop is adapted to be engaged to the first bracket and the double loop is adapted to be engaged to the second bracket.

17. The console assembly as claimed in claim 16, wherein a first end of the first bracket comprises a first portion adapted to be attached to the first box, and a second end of the first bracket comprises a hook-shaped portion adapted to engage the single loop end of the strap.
